(19) United States
(12) Patent Application Publication
(10) Pub. No.: US 2026/0071712 A1
(43) Pub. Date: Mar. 12, 2026

(54) HOSE RESTRAINT SYSTEM WITH TWO OR MORE SPACED CABLE LOOPS FOR WHIP MITIGATION

(71) Applicant: Steve Beeson, Yukon, OK (US)

(72) Inventor: Steve Beeson, Yukon, OK (US)

(21) Appl. No.: 19/387,729

(22) Filed: Nov. 13, 2025

Related U.S. Application Data
(63) Continuation-in-part of application No. 18/222,954, filed on Jul. 17, 2023.

(51) Int. Cl. F16L 55/00

(52) U.S. Cl. CPC F16L 55/005

(57) ABSTRACT

Disclosed are a method and a hose restraint assembly for a pressurized fluid hose. The assembly includes a first cable loop and a second cable loop formed from a continuous cable and spaced longitudinally apart along the hose. Each cable loop is configured to encircle the hose and terminate at a common anchoring assembly. A protective sleeve is positioned around each of the first and second cable loops and disposed in contact with the hose. The common anchoring assembly is configured to transfer tensile energy from the continuous cable to a fixed structural support during a hose failure event. The first and second cable loops are configured to constrict and tighten passively around the hose as the hose contracts under pressure.

### CLAIM OF PRIORITY

This application is a Continuation-In-Part Application of, and claims priority to, co-pending U.S. patent application Ser. No. 18/222,954 titled METHOD, DEVICE AND SYSTEM OF A HOSE RESTRAINT DEVICE INSTALLABLE ON A HOSE CARRYING A PRESSURIZED FLUID AND A FITTING THEREOF DURING OPERATION OF THE HOSE filed on Jul. 17, 2023.

### FIELD OF TECHNOLOGY

This disclosure relates generally to hose restraint devices and, more particularly, to a method, a device, and/or a system of a hose restraint device installable on a hose carrying a pressurized fluid and a fitting thereof during operation of the hose.

### BACKGROUND

High-pressure hoses used in industrial, drilling, and hydraulic systems may pose a serious risk of injury in the event of a failure at the hose or its fitting. When a pressurized hose becomes disconnected or ruptures, the sudden release of energy can cause the hose to whip violently. This unpredictable motion may strike workers in the vicinity, resulting in severe bodily harm such as lacerations, contusions, fractures, or even fatalities in extreme cases.

The speed and force of a whipping hose can be substantial, particularly when the hose is carrying fluids at thousands of pounds per square inch. Workers located near the hose may have little or no warning before impact, and the trajectory of the hose can change rapidly based on how and where the failure occurs. A whipping hose may strike the head, limbs, or torso of personnel, and injuries can be compounded by falling debris, equipment damage, or secondary fluid spray.

Improperly restrained hoses may also recoil unexpectedly, especially when a hose detaches from a fitting but remains partially pressurized. This behavior can cause the hose to spin, twist, or lash in a wide radius, making injury avoidance difficult. In confined spaces, the likelihood of injury may increase due to limited escape routes and close proximity to machinery.

Even when hose restraints are used, incorrect installation or poor placement may reduce their effectiveness. If a restraint fails to engage properly during a pressure release event, the hose can still become airborne or rotate uncontrollably. As a result, injury risks may persist even in systems that appear secured under normal operating conditions. Because pressurized hoses are common in a wide range of industries, from construction and oilfield services to manufacturing and chemical processing, the potential for whip-related injuries may arise in many environments where hoses are used regularly.

### SUMMARY

Disclosed are a method, a device, and/or a system of a hose restraint system with two or more spaced cable loops for whip mitigation.

In one aspect, a hose restraint assembly for a pressurized fluid hose includes a first cable loop and a second cable loop formed from a continuous cable and spaced longitudinally apart along the hose. Each cable loop is configured to encircle the hose and is connected to a common anchoring assembly. A protective sleeve is positioned around each of the first and second cable loops and is in contact with the hose. The common anchoring assembly is configured to transfer tensile energy from the continuous cable to a fixed structural support during a hose failure event. The first and second cable loops are configured to constrict and tighten passively around the hose as the hose contracts under pressure.

The hose restraint assembly may include the first cable loop and the second cable loop spaced apart by a distance between 8 and 16 inches along the length of the hose. The hose restraint assembly may include a protective sleeve made of an abrasion-resistant material selected from polyester, neoprene, polyurethane, and/or a woven textile composite. The hose restraint assembly may include the continuous cable formed as a multi-stranded steel cable coated with a corrosion-resistant polymer. The hose restraint assembly may include the common anchoring assembly having a swaged metallic eyelet and/or a clevis connector configured to interface with a shackle and/or a rig-mounted fixture. Each of the first cable loop and/or the second cable loop may include a thimble insert positioned between the cable and the hose surface, the thimble configured to reduce deformation of the hose during constriction. The protective sleeves may be permanently fixed to the cable loops to prevent axial sliding during operation. The hose may be a high-pressure industrial hose selected from hydraulic, pneumatic, frac, and/or mud hoses. The continuous cable may terminate at the common anchoring assembly through swaged and/or crimped ferrules formed at each cable leg. The hose restraint assembly may be configured for installation without detaching the hose from its pressurized connection and/or fitting. The first and second cable loops may be dimensioned and positioned to dissipate tensile energy by engaging discrete outer surface regions of the hose during a whip-inducing failure event.

In another aspect, a hose restraint device includes a flexible cable formed into first and second loops that are spaced apart along a hose and wrap around its outer surface. A protective sleeve is positioned over portions of the loops and is made of a flexible, abrasion-resistant material such as polyester, rubber, and/or a polymer composite. The sleeve interfaces directly with the hose surface to minimize compression and wear. An insert may be positioned between the cable and the hose within one or both loops to distribute pressure and prevent pinching of the hose wall. The opposing ends of the cable are terminated by crimped ferrules that secure the cable and maintain the looped geometry. The cable is configured to automatically tighten around the hose when axial tension occurs during a pressurized fluid failure, causing both loops to constrict together and restrain the hose. The longitudinal spacing between the loops is selected to improve energy absorption and distribute load along multiple areas of the hose body.

The hose restraint device may have the longitudinal spacing between the first loop and the second loop set between 8 inches and 16 inches. The protective sleeve may include an inner lining layer that reduces friction between the cable and the hose surface. The flexible cable may be formed from multi-stranded steel wire with a corrosion-resistant coating. The ferrules may be made of aluminum, stainless steel, and/or another metallic alloy and may be mechanically swaged onto the cable ends to prevent slippage. Both the first loop and the second loop may be formed from a pre-measured cable length selected for a specific hose diameter range. The protective sleeve may be heat-shrunk and/or bonded to the cable to prevent relative movement between the sleeve and the cable during use. The device may include a thimble and/or spool insert made of a non-metallic composite material chosen for impact dispersion and thermal resistance. The cable may constrict without external tensioning hardware, relying solely on induced axial force from hose contraction and pressure reversal. The device may be installed on the hose without disconnecting the hose from its fitting. The first loop and/or the second loop may be color-coded and/or marked to indicate proper placement along the hose during installation.

In yet another aspect, a multi-loop hose choker system includes a plurality of cable loops spaced longitudinally along a pressurized hose. A protective sleeve surrounds each of the plurality of cable loops. The thimble and/or spool insert is optionally disposed between each cable loop and the surface of the hose. An anchoring assembly is coupled to the ends of the cable and is attachable to a structural frame. The two staggered loops are configured to progressively cinch onto the hose surface in response to axial load resulting from a coupling and/or pressure failure. This configuration distributes force across multiple locations and reduces hose whip. A crimped termination is fixed at each end of the cable to secure the loops.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an illustrative view of a hose restraint device, according to one or more embodiments.

FIG. 2 is an illustrative view of loop-based connections being made using the hose restraint device of FIG. 1, according to one or more embodiments.

FIG. 3 is an illustrative view of example loop-based connections formed around a hose and a fitting thereof in a hydraulic/pneumatic system using the hose restraint device of FIGS. 1-2.

FIG. 4 is a mathematical formulation of design considerations pertaining to the hose restraint device of FIGS. 1-3, according to one or more embodiments.

FIG. 5 is a process flow diagram detailing the operations involved in coupling a hose restraint device to a hose carrying a pressurized fluid and a fitting thereof, according to one or more embodiments.

FIG. 6 is a perspective view of a double cable hose choker showing two staggered cable loops encircling a hose and terminating at a common anchor junction, according to one or more embodiments.

FIG. 7 is a side elevation view illustrating the relative longitudinal placement of the two cable loops along a hose, one positioned farther from the hose coupling than the other, according to one or more embodiments.

FIG. 8 is a cross-sectional view through a cable loop showing the cable routed within a protective sleeve and optionally interfacing with a spool or thimble adjacent to the hose surface, according to one or more embodiments.

FIG. 9 is a sequential view illustrating the tightening of the cable loops during a failure event, transitioning from a pressurized hose state to a cinched state as the hose contracts, according to one or more embodiments.

FIG. 10 is a perspective view of a multi-loop choker configuration including four spaced cable loops distributed along a hose and joined to a common or split anchor assembly, according to one or more embodiments.

FIG. 11 is a comparative view showing two loop termination styles, including a quick-link mechanism and a fixed closed-loop ferrule, according to one or more embodiments.

FIG. 12 is an application view showing the double cable hose choker installed on a pressurized hose in an operational environment such as a drilling rig or fracking site, with the anchor secured to a fixed structure, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of a hose restraint device installable on a hose carrying a pressurized fluid and a fitting thereof during operation of the hose. Although the present embodiments have been described with reference to specific example embodiments, it will be evident that various modifications and changes may be made to these embodiments without departing from the broader spirit and scope of the various embodiments.

In one embodiment, a hose restraint assembly 100 for a pressurized fluid hose 302 includes a first cable loop 602₁ and a second cable loop 602₂ formed from a continuous cable 102 and spaced longitudinally apart along the hose 302. Each cable loop 602₁, 602₂ is configured to encircle the hose and is connected to a common anchoring assembly. A protective sleeve 606 is positioned around each of the first and second cable loops and is in contact with the hose 302. The common anchoring assembly 612 is configured to transfer tensile energy from the continuous cable 102 to a fixed structural support 702 during a hose failure event. The first and second cable loops 602₁, 602₂ are configured to constrict and tighten passively around the hose 302 as the hose contracts under pressure.

The hose restraint assembly 100 may include the first cable loop 602₁ and the second cable loop 602₂ spaced apart by a distance between 8 and 16 inches along the length of the hose 302. The hose restraint assembly 100 may include a protective sleeve 606 made of an abrasion-resistant material selected from polyester, neoprene, polyurethane, and/or a woven textile composite. The hose restraint assembly 100 may include the continuous cable 102 formed as a multi-stranded steel cable coated with a corrosion-resistant polymer. The hose restraint assembly 100 may include the common anchoring assembly 612 having a swaged metallic eyelet and/or a clevis connector configured to interface with a shackle 1204 and/or a rig-mounted fixture. Each of the first cable loop 602₁ and/or the second cable loop 602₂ may include a thimble 608 insert positioned between the cable 102 and the hose surface 302, the thimble 608 configured to reduce deformation of the hose during constriction. The protective sleeves 606 may be permanently fixed to the cable loops 602₁, 602₂ to prevent axial sliding during operation. The hose 302 may be a high-pressure industrial hose selected from hydraulic, pneumatic, frac, and/or mud hoses. The continuous cable 102 may terminate at the common anchoring assembly 612 through swaged and/or crimped ferrules formed at each cable leg. The hose restraint assembly 100 may be configured for installation without detaching the hose 302 from its pressurized connection and/or fitting 304. The first and second cable loops 602₁, 602₂ may be dimensioned and positioned to dissipate tensile energy by engaging discrete outer surface regions of the hose 302 during a whip-inducing failure event.

In another embodiment, a hose restraint device 100 includes a flexible cable 102 formed into first and second loops 602₁, 602₂ that are spaced apart along a hose 302 and wrap around its outer surface. A protective sleeve 606 is positioned over portions of the loops 602₁, 602₂, and is made of a flexible, abrasion-resistant material such as polyester, rubber, and/or a polymer composite. The sleeve 606 interfaces directly with the hose surface 302 to minimize compression and wear. An insert 610 may be positioned between the cable 102 and the hose 302 within one or both loops 602₁, 602₂ to distribute pressure and prevent pinching of the hose wall. The opposing ends of the cable 102 are terminated by crimped ferrules 604 that secure the cable and maintain the looped geometry. The cable 102 is configured to automatically tighten around the hose 302 when axial tension occurs during a pressurized fluid failure, causing both loops 602₁, 602₂ to constrict together and restrain the hose 302. The longitudinal spacing between the loops 602₁, 602₂ is selected to improve energy absorption and distribute load along multiple areas of the hose body 302.

The hose restraint device 100 may have the longitudinal spacing between the first loop 602₁ and the second loop 602₂ set between 8 inches and 16 inches. The protective sleeve 606 may include an inner lining layer that reduces friction between the cable 102 and the hose surface 302. The flexible cable 102 may be formed from multi-stranded steel wire with a corrosion-resistant coating. The ferrules 604 may be made of aluminum, stainless steel, and/or another metallic alloy and may be mechanically swaged onto the cable ends to prevent slippage. Both the first loop 602₁ and the second loop 602₂ may be formed from a pre-measured cable length selected for a specific hose diameter range. The protective sleeve 606 may be heat-shrunk and/or bonded to the cable 102 to prevent relative movement between the sleeve 606 and the cable 102 during use. The device 100 may include a thimble 608 and/or spool insert 610 made of a non-metallic composite material chosen for impact dispersion and thermal resistance. The cable 102 may constrict without external tensioning hardware, relying solely on induced axial force from hose contraction and pressure reversal. The device 100 may be installed on the hose 302 without disconnecting the hose from its fitting 304. The first loop 602₁ and/or the second loop 602₂ may be color-coded and/or marked to indicate proper placement along the hose 302 during installation.

In yet another embodiment, a multi-loop hose choker system 1000 includes a plurality of cable loops 602₁, 602₂, 1004₁, 1004₂ spaced longitudinally along a pressurized hose 302. A protective sleeve 606 surrounds each of the plurality of cable loops. The thimble 608 and/or spool insert 610 is optionally disposed between each cable loop and the surface of the hose 302. An anchoring assembly 612 is coupled to the ends of the cable 102 and is attachable to a structural frame 702. The two staggered loops 602₁, 602₂ are configured to progressively cinch onto the hose surface 302 in response to axial load resulting from a coupling 304 and/or pressure failure. This configuration distributes force across multiple locations and reduces hose whip. A crimped termination 604 is fixed at each end of the cable 102 to secure the loops 602₁, 602₂.

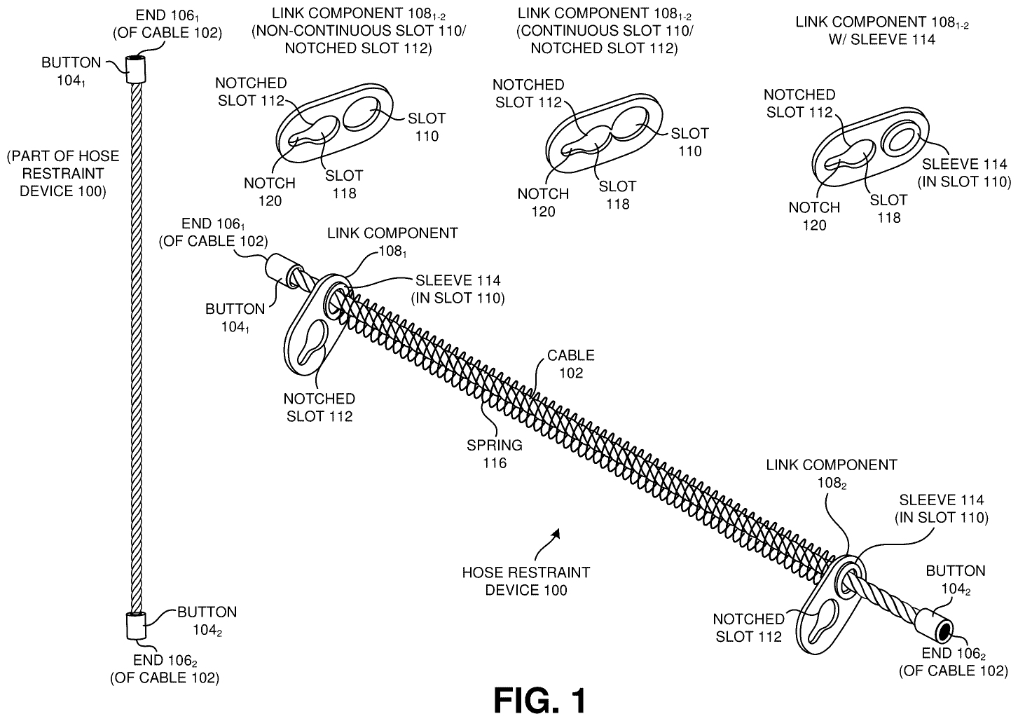

FIG. 1 shows a hose restraint device 100, according to one or more embodiments. In one or more embodiments, hose restraint device 100, as discussed herein, may refer to a device directly injection moulding and heavy hydraulic and/or pneumatic presses may be dangerous to personnel in coupled to a hose carrying a pressurized fluid (e.g., liquid and/or gas) and a fitting thereof for the purpose of preventing a whip effect when the hose separates from the fitting and/or breaks connection therefrom due to the high pressure level of the fluid carried therethrough. The high pressure level of the fluid May cause movement of the hose, which, in turn, may also cause the fitting to detach and/or separate. The whip effect may cause serious injuries to a user associated with the hose and/or personnel in a vicinity thereof; the unpredictability of the whip effect may cause the fluid carried through the hose to be spilled on to the user. Pressurized hoses may, for example, be employed in the vicinity of the hose if the hose separates from the fitting and travels out to strike said personnel.

Typical hose restraint devices may require interruption in the hose connection for installation thereof. In other words, the hose may have to be disconnected from the fitting thereof in order for a typical hose restraint device to be installed thereon. Organizations may be hesitant to install these hose restraint devices because equipment may have to be shut down therefor, the fluid supply disconnected and existing fluid in the hose drained prior to installation. Thus, the possibility of contaminants entering the system, environmental issues being aggravated due to the leakage of the fluid and/or system downtime may be increased upon installation of these typical hose restraint devices. Exemplary embodiments at least in the form of hose restraint device 100 discussed herein may reduce the occurrences of the whip effect based on hose restraint device 100 holding on to the hose and the fitting thereof even when the hose carrying a highly pressurized fluid separates from the fitting. Further, in one or more embodiments, hose restraint device 100 may be installed on the hose and the fitting thereof without disconnecting the hose carrying the highly pressurized fluid. Exemplary embodiments, as typified at least by hose restraint device 100, may be advantageously employed in industries and large scale industrial plants through integration thereof on to existing hoses and equipment.

Referring back to FIG. 1, in one or more embodiments, hose restraint device 100 may include a bendable cable 102 and buttons 104₁₋₂ at ends 106₁₋₂ thereof. In one or more embodiments, cable 102 may be made of a metallic material such as aluminium, copper, steel, stainless steel, an alloy and/or a composite. In some embodiments, cable 102 may be made of a corrosion-resistant material that provides for high tensile strength. In one or more embodiments, buttons 104₁₋₂ may also be made of metallic material (e.g., steel, stainless steel, coated steel, aluminium, copper, an alloy, a composite). In one or more embodiments, each button 104₁₋₂ may be cylindrical in shape in correspondence with a shape of cable 102 and may have a higher cross-sectional diameter than cable 102. However, the cylindrical shape of buttons 104₁₋₂ should not be considered limiting and that other shapes such as that of a rectangular prism and a cuboid are within the scope of the exemplary embodiments discussed herein. In one or more embodiments, a length of each button 104₁₋₂ may be significantly smaller than a length of cable 102 to enable limitation of the presence of buttons 104₁₋₂ at ends 106₁₋₂ of cable 102. In one or more embodiments, a portion of cable 102 proximate each end 106₁₋₂ thereof may pass through a corresponding button 104₁₋₂ and be held therethrough until said each end 106₁₋₂.

In one or more embodiments, cable 102 may include a number of sub-cables twisted into one another. In addition to the aforementioned components, in one or more embodiments, hose restraint device 100 may include two link components 108₁₋₂ to be utilized for anchoring cable 102 proximate each end 106₁₋₂ thereto following establishment of loop-based connections to the hose and the fitting thereof, as will be discussed below. In one or more embodiments, each link component 108₁₋₂ may also be made of a metallic material (e.g., steel, coated steel, aluminium, copper, stainless steel, an alloy, a composite). As shown in FIG. 1, in one or more embodiments, a link component 108₁₋₂ may include a slot 110 and a notched slot 112 adjacent to each other. In some embodiments, slot 110 and notched slot 112 may be non-continuous and/or contiguous and, in some other embodiments, slot 110 and notched slot 112 may touch each other and, optionally, even share a minimal common portion. FIG. 1 shows both non-continuous and continuous slot/notched slot embodiments of link components 108₁₋₂, according to one or more embodiments.

In one or more embodiments, a dimensional length of each link component 108₁₋₂ may again be significantly small than that of cable 102. In one or more embodiments, cable 102 may be passed through slot 110 of each link component 108₁₋₂. In one or more embodiments, for a smooth and/or a stable passage of cable 102 through slot 110, slot 110 of each link component 108₁₋₂ may include a sleeve 114 (e.g., a polyester sleeve) provided therein. In one example embodiment, sleeve 114 may be a ring placed within slot 110 and cable 102 may pass through sleeve 114 of slot 110. In one or more embodiments, link component 108₁ may be associated with anchoring cable 102 proximate end 106₁ and link component 108₂ may be associated with anchoring cable 102 proximate end 106₂ following formation of the loop-based connections discussed above.

In one or more embodiments, in a state of cable 102 passing through slot 110/sleeve 114 of each link component 108₁₋₂, a spring 116 (e.g., made of metallic material such as steel, stainless steel, copper, coated steel, aluminium, an alloy and a composite) may be provided between link component 108₁ and link component 108₂. In one or more embodiments, spring 116 may encompass a significant portion of cable 102 therein; in other words, a significant portion/length of cable 102 may pass through spring 116 and be encompassed thereby. In one or more embodiments, spring 116 may be compressed (e.g., held to a compressed state using common tools such as pliers, using link component 108₁₋₂) to reveal an appropriate length of cable 102 to go over a hose at end 106₁ and a fitting thereof at end 106₂, as will be discussed below. In one or more embodiments, once the loop-based connection of cable 102 is made, a restoring force of spring 116 may enable spring 116 to expand back enough to be delimited solely by link components 108₁₋₂ as boundaries thereof.

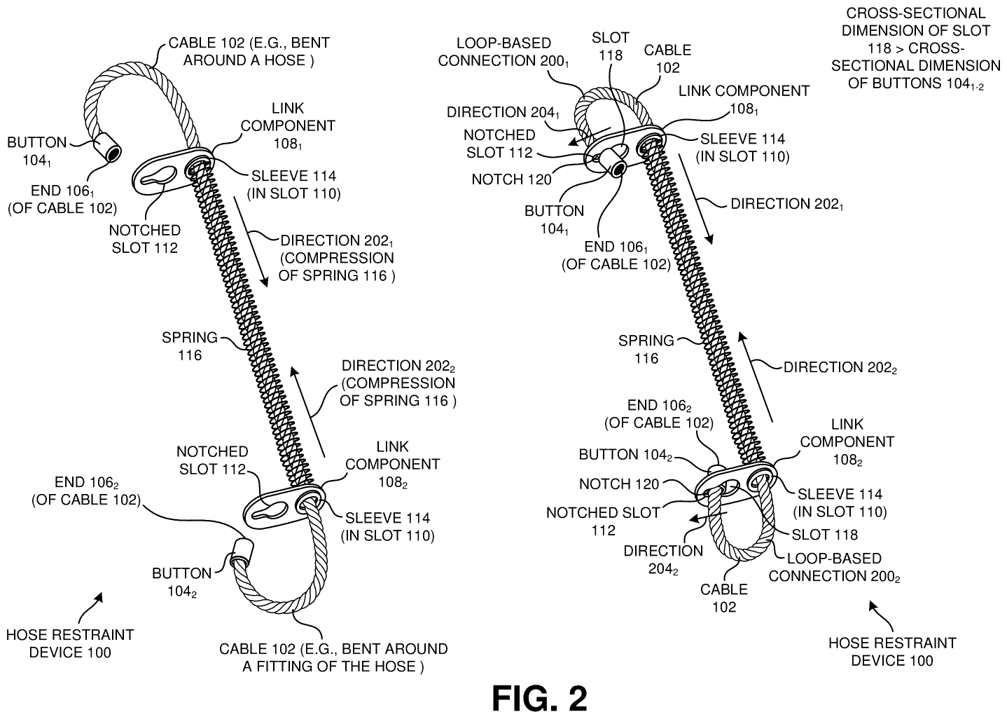

FIG. 2 shows loop-based connections 200₁₋₂ being made proximate end 106₁ and end 106₂ of cable 102 of hose restraint device 100, according to one or more embodiments. In one or more embodiments, as discussed above, cable 102 may pass through slot 110 of each link component 108₁₋₂ and a compressible spring 116 may be provided between link component 108₁ and link component 108₂. In one or more embodiments, in order for loop-based connections 200₁₋₂ to be made, an appropriate length of cable 102 at one end 106₁₋₂ may be revealed as per a requirement of said length to completely go over a hose or a fitting thereof based on compression of spring 116 in a direction 202₁₋₂ toward the other end 106₁₋₂. In one or more embodiments, this compression of spring 116 may be accomplished based on depressing link component 108₁₋₂ along direction 202₁₋₂, holding link component 108₁₋₂ to keep spring 116 compressed in direction 202₁₋₂ and/or utilizing a common tool such as pliers to keep spring 116 compressed in direction 202₁₋₂.

In one or more embodiments, the compression of spring 116 may render it possible for the appropriate length of cable 102 at end 106₁₋₂ to emerge out of slot 110 of link component 108₁₋₂. In one or more embodiments, the appropriate lengths of cable 102 may be bent over the hose (not shown in FIG. 2) proximate end 106₁ and the fitting (not shown in FIG. 2) proximate end 106₂ to go over the hose and the fitting to form a first loop covering the hose and a second loop covering the fitting. In one or more embodiments, following the formation of the loops, button 104₁₋₂ at end 106₁₋₂ may be inserted into notched slot 112. Referring back to FIG. 1, notched slot 112 may include a slot (e.g., slot 118) continuous with a notch (e.g., notch 120) at a lateral side thereof, with slot 118 having a cross-sectional diameter larger than that of button 104₁₋₂ at end 106₁₋₂ and notch 120 having a thickness/width lesser than the cross-sectional diameter of button 104₁₋₂ at end 106₁₋₂ but more than the cross-sectional diameter of cable 102. It should be noted that the shapes of slot 110 and notched slot 112 are not limiting and that cross-sectional diameters may be generalized to cross-sectional dimensions.

In one or more embodiments, insertion of button 104₁₋₂ at end 106₁₋₂ completely into slot 118 of notched slot 112 of a corresponding link component 108₁₋₂ may cause a portion of cable 102 of the loop formed to automatically move in a direction 204₁₋₂ approximately perpendicular to direction 202₁₋₂ and be received within notch 120, thus forming loop-based connection 200₁₋₂ at a corresponding end 106₁₋₂. In one or more embodiments, the bending of cable 102 may provide a restoring force along direction 204₁₋₂ to enable the portion of cable 102 of the loop formed to be received within notch 120. In this state, in one or more embodiments, cable 102 proximate end 106₁₋₂ may be anchored within link component 108₁₋₂ as discussed above. In one or more embodiments, the relative dimensions of button 104₁₋₂, cable 102, slot 110, slot 118 and notch 120 and the restoring force of the bent portion of cable 102 may make it possible for the anchoring to be robust and stable such that cable 102 and button 104₁₋₂ do not pop out of link component 108₁₋₂ (slot 110 and notched slot 112 (slot 118 and notch 120)).

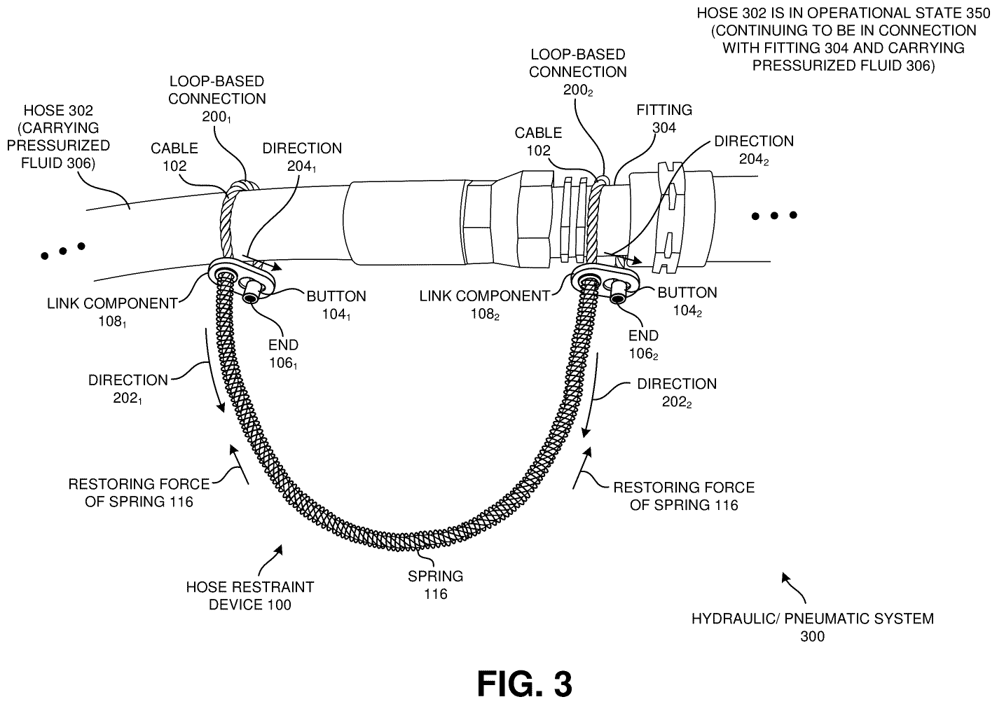

FIG. 3 shows example loop-based connections 200₁₋₂ formed around a hose 302 and a fitting 304 of hose 302 using hose restraint device 100. In one or more embodiments, hose 302 may be part of a hydraulic/pneumatic system 300 and may be carrying a pressurized fluid therethrough. In one example scenario, hose 302 may be coupled to a Joint Industry Council (JIC) fitting. The JIC fitting may have a threaded port on another side thereof to which a hydraulic block may be screwed. Fitting 304 here may be part of the hydraulic block. Loop-based connection 200₁ may be formed around hose 302 based on a portion of cable 102 proximate end 106₁ going around hose 102 and said portion being anchored at link component 108₁. Loop-based connection 200₂ may be formed around fitting 304 based on a portion of cable 102 proximate end 106₂ going around fitting 304 and said portion being anchored at link component 108₂. In FIG. 3, although cable 102 of hose restraint device 100 is curved and bent in a state of connection to hose 302 and fitting 304, direction 202₁₋₂ may be shown as being along the approximate unbent portions of cable 102. Once loop connections 200₁₋₂ are made, portions of cable 102 proximate end 106₁ and end 106₂ may hold on to hose 302 and fitting 304 respectively.

In one or more embodiments, the mechanism of coupling/connection of hose restraint device 100 to hose 302 and fitting 304 may make it possible for hose restraint device 100 to be connected to/installed on hose 302 and fitting 304 in a state of operation (e.g., operational state 350) of hose 302 in which a pressurized fluid (e.g., pressurized fluid 306) is carried via hose 302 and hose 302 continues to be attached to fitting 304 without the need to remove/disconnect hose 302 from fitting 304. In other words, in one or more embodiments, hose restraint device 100 may be connected/coupled to hose 302 and fitting 304 or installed thereon during the state of operation thereof. In one or more embodiments, as equipment need not be shut down, supply of pressurized fluid 306 need not be disconnected and hose 302 need not be drained prior to installing hose restraint device 100 on hose 302 and fitting 304, hydraulic/pneumatic system 300 may have advantages pertaining to continued and uninterrupted operation of hose 302 and increased safety arising out of reduced leaks of pressurized fluid 306.

It should be noted that, in some embodiments, fitting 304 may be part of a split flange based coupling, where port-hose 302 connections and/or hose-hose (analogous to hose 302) connections may be made. Here, hose restraint device 100, as discussed above, may be installed on hose 302 and fitting 304 based on loop-based connections 200₁₋₂ without breaking connection between hose 302 and fitting 304. All possible types of fitting 304 and coupling thereof are within the scope of the exemplary embodiments discussed herein.

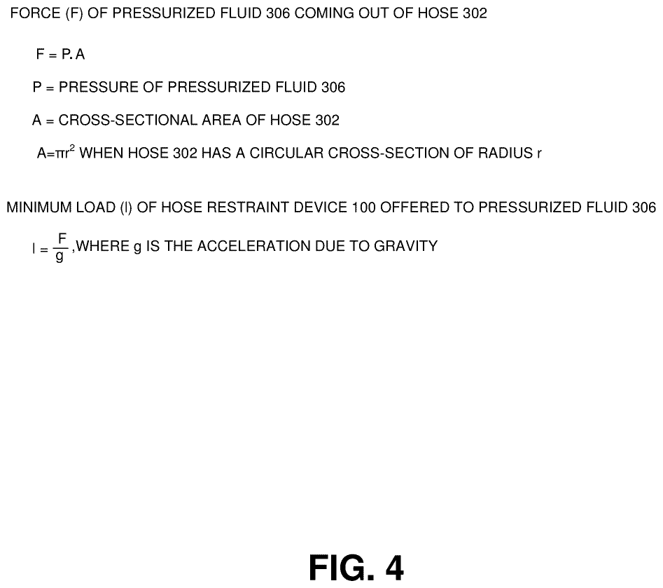

FIG. 4 shows design considerations pertaining to hose restraint device 100, according to one or more embodiments. In one or more embodiments, a force (F) of pressurized fluid 306 coming out of hose 302 may be related to a cross-sectional area (A) of hose 302 and pressure (P) of pressurized fluid 306 as:

$$F = P \cdot A$$

In one or more embodiments, in the case of a circular cross-section of hose 302, A=πr², where r is the cross-sectional radius of hose 302. Thus, in one or more embodiments, the minimum load (l) of hose restraint device 100 offered to pressurized fluid 306 may be calculated as:

$$l = \frac{F}{g} ,$$

where g is the acceleration due to gravity.

In one or more embodiments, the aforementioned minimum load may have to be scaled by a factor to realize a desired load offered by hose restraint device 100. In one or more embodiments, all components of hose restraint device 100 discussed above may have to be designed such that the aforementioned minimum load is met by hose restraint device 100. In one example implementation, hose restraint device 100 may hold on to hose 302 and fitting 304 even when the connection between hose 302 and fitting 304 breaks at 8200 Pounds Per Square Inch (PSI). Thus, not only may hose restraint device 100 hold onto hose 302 and fitting 304 into a stable mode of operation (e.g., operational state 350) until the pressure of pressurized fluid 306 goes up to 8200 PSI but also hose restraint device 100 may hold onto hose 302 and fitting 304 even upon failure of the connection thereof when the pressure of pressurized fluid 306 exceeds 8200 PSI.

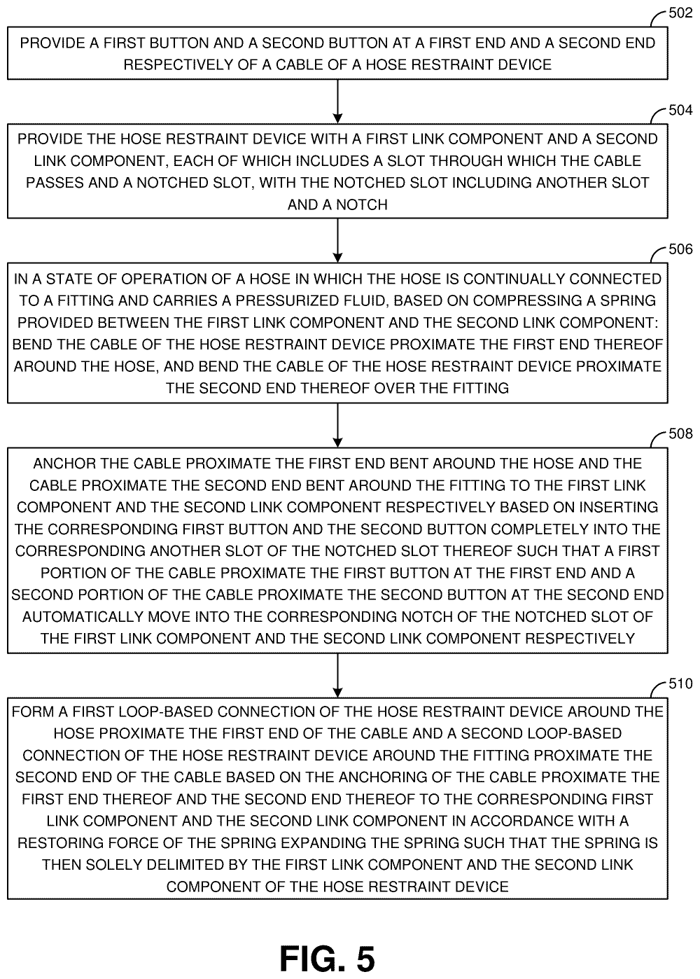

FIG. 5 shows a process flow diagram detailing the operations involved in coupling a hose restraint device (e.g., hose restraint device 100) to a hose (e.g., hose 302) carrying a pressurized fluid (e.g., pressurized fluid 306) and a fitting (e.g., fitting 304) thereof, according to one or more embodiments. In one or more embodiments, operation 502 may involve providing a first button (e.g., button 104₁) and a second button (e.g., button 104₂) at a first end (e.g., end 106₁) and a second end (e.g., end 106₂) respectively of a cable (e.g., cable 102) of the hose restraint device. In one or more embodiments, operation 504 may involve providing the hose restraint device with a first link component (e.g., link component 108₁) and a second link component (e.g., link component 108₂), each of which includes a slot (e.g., slot 110) through which the cable passes and a notched slot (e.g., notched slot 112). In one or more embodiments, the notched slot may include another slot (e.g., slot 118) and a notch (e.g., notch 120).

In a state of operation (e.g., operational state 350) of the hose in which the hose is continually connected to the fitting and carries the pressurized fluid, several operations pertaining to the hose restraint device may be performed; the operations following this may constitute some of the aforementioned several operations. In one or more embodiments, operation 506 may involve, based on compressing a spring (e.g., spring 116) provided between the first link component and the second link component, bending the cable of the hose restraint device proximate the first end thereof around the hose, and bending the cable of the hose restraint device proximate the second end thereof over the fitting.

In one or more embodiments, operation 508 may involve anchoring the cable proximate the first end bent around the hose and the cable proximate the second end bent around the fitting to the first link component and the second link component respectively based on inserting the corresponding first button and the second button completely into the corresponding another slot of the notched slot thereof such that a first portion of the cable proximate the first button at the first end and a second portion of the cable proximate the second button at the second end automatically move into the corresponding notch of the notched slot of the first link component and the second link component respectively. In one or more embodiments, operation 510 may then involve forming a first loop-based connection (e.g., loop-based connection 200₁) of the hose restraint device around the hose proximate the first end of the cable and a second loop-based connection (e.g., loop-based connection 200₂) of the hose restraint device around the fitting proximate the second end of the cable based on the anchoring of the cable proximate the first end thereof and the second end thereof to the corresponding first link component and the second link component in accordance with a restoring force of the spring expanding the spring such that the spring is then solely delimited by the first link component and the second link component of the hose restraint device.

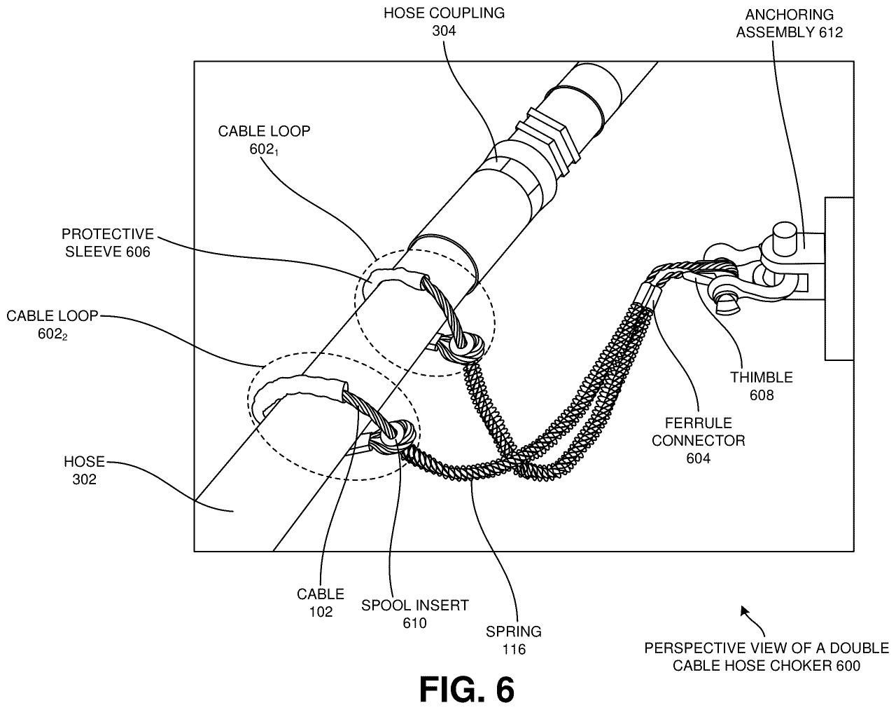

FIG. 6 is a perspective view of a double cable hose choker showing two staggered cable loops encircling a hose and terminating at a common anchor junction, according to one or more embodiments. FIG. 6 is a perspective view of a double cable hose choker assembly 600 configured with two staggered cable loops to restrain a hose 302 carrying pressurized fluid, according to one or more embodiments. The hose 302 may be similar to that shown in FIG. 3. A cable loop 602₁ (e.g., first cable loop) and a cable loop 602₂ (e.g., second cable loop) are formed from a shared cable similar to 102 (as introduced in FIG. 1) and spaced apart longitudinally along the hose 302, according to this embodiment. Each cable loop is encased in a protective sleeve 606, which may include a polyester and/or rubber sheath similar to sleeve 114 discussed with respect to FIG. 1, according to this embodiment. Both cable loops terminate at a common anchoring assembly 612 comprising an eyelet and/or a ferrule connector 604, according to this embodiment. The cable loop 602₁ (e.g., first cable loop) is positioned closer to a hose coupling 304, and the cable loop 602₂ (e.g., second cable loop) is located further downstream, according to this embodiment. The ferrule connectors 604 are shown at the terminations of each cable leg, and may be swaged and/or crimped into place, according to this embodiment. This configuration differs structurally from the hose restraint device 100 of FIG. 1 by providing two points of constriction and anchoring to distribute force more effectively in high-pressure scenarios, according to this embodiment.

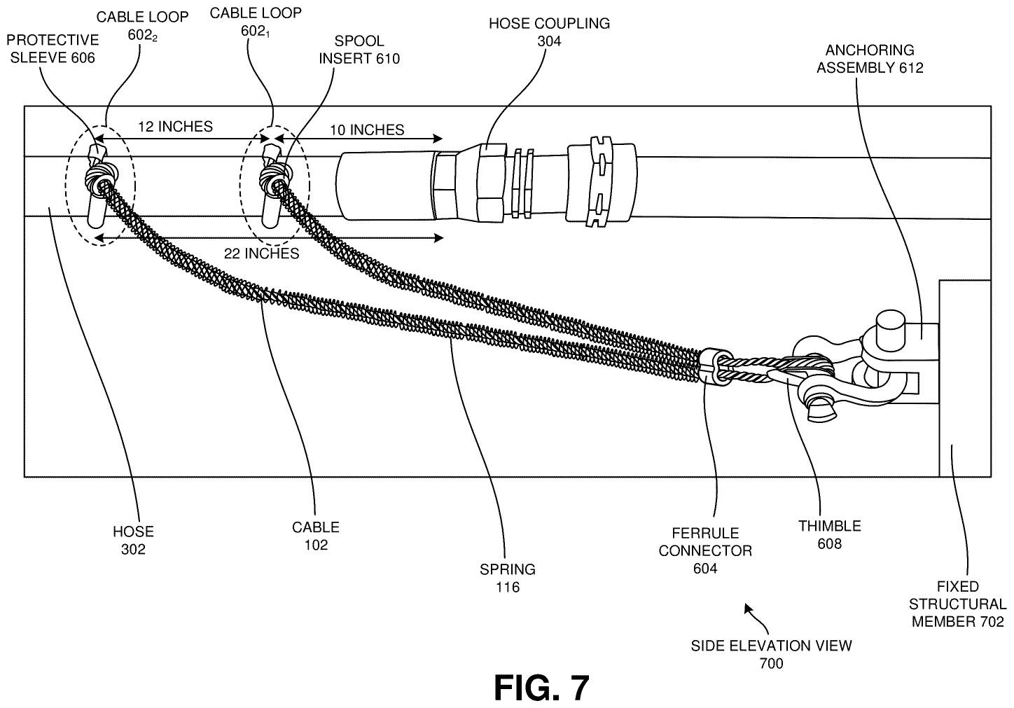

FIG. 7 is a side elevation view 700 illustrating the relative longitudinal placement of the two cable loops along a hose, one positioned farther from the hose coupling than the other, according to one or more embodiments. FIG. 7 is a side elevation view illustrating the longitudinal placement of cable loops 602₁ and 602₂ along the hose 302, according to one or more embodiments. The cable loops 602₁ and 602₂ are spaced approximately 12 inches apart to maximize energy absorption and improve grip reliability, according to this embodiment. The cable loop 602₁ is positioned approximately 10 inches from the hose coupling 304 (as also shown in FIG. 3), and the cable loop 602₂ is approximately 22 inches away from the hose coupling 304. The anchoring assembly 612 is connected to a fixed structural member 702, such as a rig post, pipe rack, and/or cross beam. The protective sleeves 606 remain positioned around each cable loop as in FIG. 6, according to this embodiment. The side elevation view 700 also illustrates installation directions using arrows, suggesting correct orientation for tension loading during a failure event, according to this embodiment.

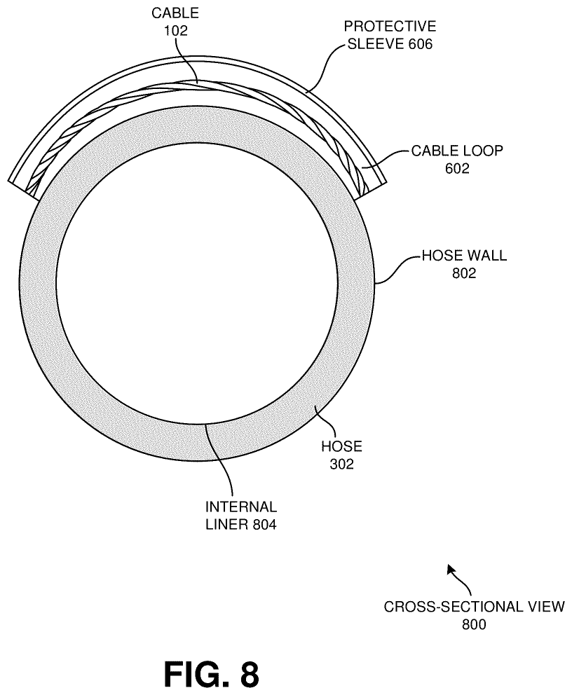

FIG. 8 is a cross-sectional view 800 through a cable loop showing the cable routed within a protective sleeve and optionally interfacing with a spool or thimble adjacent to the hose surface, according to one or more embodiments. FIG. 8 is a cross-sectional view 800 of the cable loop 602₁ positioned around the hose 302, according to one or more embodiments. Similar to the cable 102 is routed through the protective sleeve 606, the embodiment in FIG. 8 may optionally include an internal liner 804, according to this embodiment. A spool insert 610 is disposed between the cable 102 and the hose 302 outer surface to reduce pinching, enable even compression, and protect the hose wall 802. The hose 302 may include a reinforcing mesh layer and an outer jacket, which are shown interacting with the protective sleeve 606 and the insert 608, according to this embodiment.

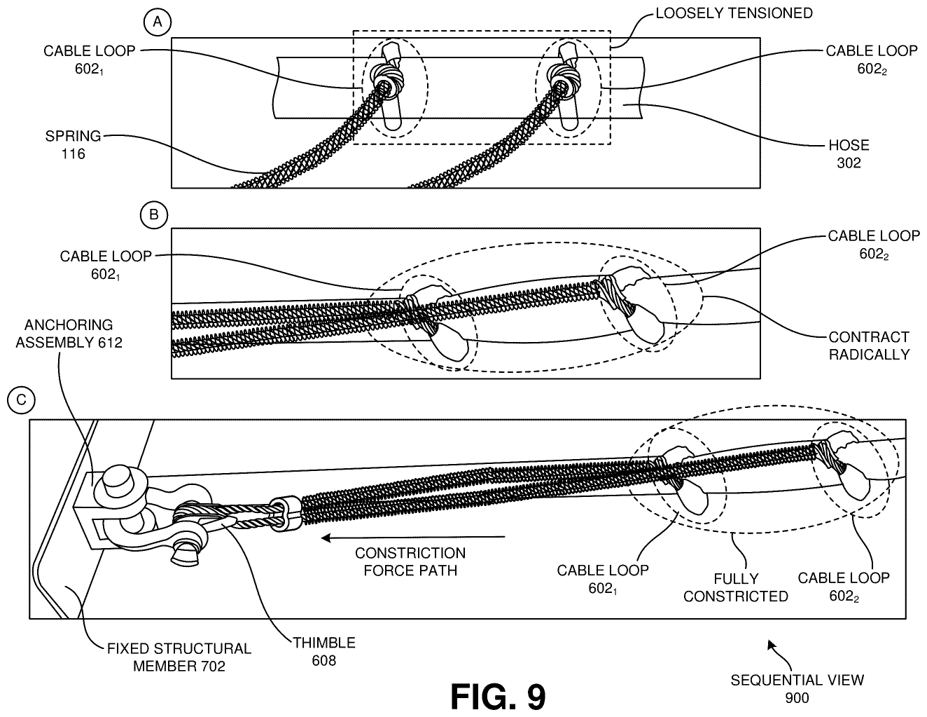

FIG. 9 is a sequential view 900 illustrating the tightening of the cable loops during a failure event, transitioning from a pressurized hose state to a cinched state as the hose contracts, according to one or more embodiments. FIG. 9 is a sequential view 900 showing dynamic loop tightening during the hose 302 failure event, according to one or more embodiments. Panel A illustrates hose 302 in a normal pressurized condition with the cable loop 602₁ and the cable loops 602₂ loosely tensioned, according to this embodiment. Panel B illustrates partial pressure loss and/or coupling failure, during which the hose 302 begins to contract radially 802 and axial tension begins to rise, according to this embodiment. Panel C shows full tightening of the cable loop 602₁ and the cable loops 602₂, now fully constricted onto the hose 302 as tensile energy is absorbed, according to this embodiment. The anchor anchoring assembly 612 transfers energy to a fixed structural member 702. The protective sleeve 606 and the thimble 608 assist in load distribution and the hose 302 protection, according to this embodiment. Arrows illustrate the constriction force path, and the cable 102 tightens passively under load, similar to the spring-returned loop formation in FIGS. 1-2, according to this embodiment.

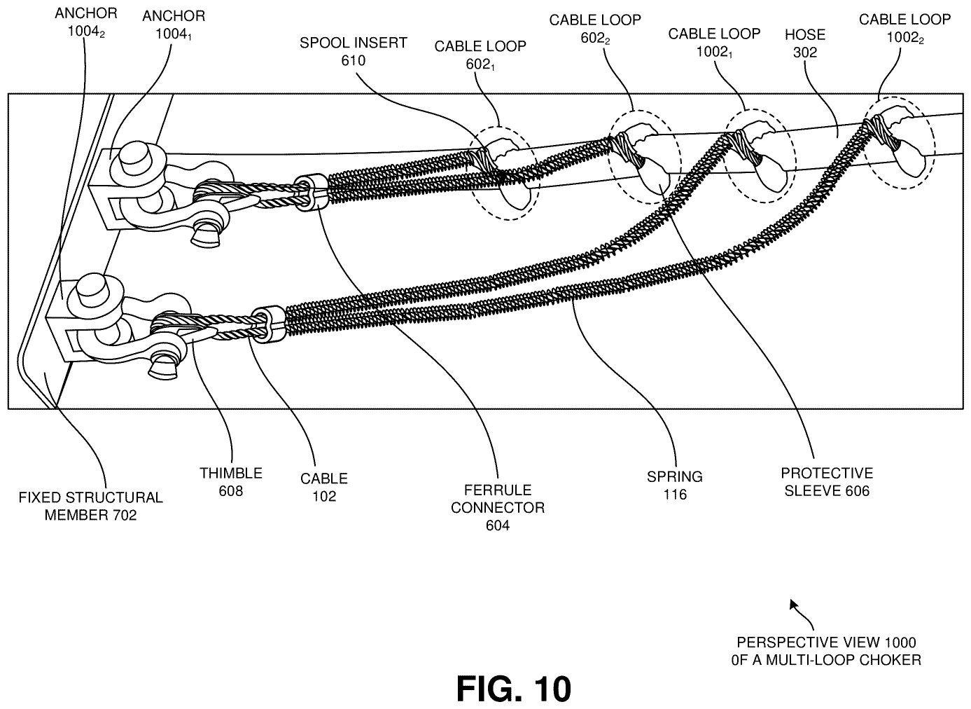

FIG. 10 is a perspective view 1000 of a multi-loop choker configuration including four spaced cable loops distributed along a hose and joined to a common or split anchor assembly, according to one or more embodiments. FIG. 10 is a perspective view 1000 of a multi-loop choker embodiment featuring four cable loops, according to one or more embodiments. Each cable loop wraps around the hose 302 and is covered with the protective sleeve 606, according to this embodiment. Additional cable loops 1002₁ and 1002₂ are spaced farther down the hose 302 length and may be connected either to the anchoring assembly 612 and/or distributed across dual anchors (e,g, anchor 1004₁ and anchor 1004₂ to reduce peak loads, according to this embodiment. This embodiment builds upon the dual-loop design shown in FIG. 6 by increasing the number of hose 302 contact points for high-impact energy dissipation, according to this embodiment. Each cable loop may be fixed in position via the ferrule connector 604 and/or crimped buttons similar to buttons 104₁₋₂ of FIG. 1.

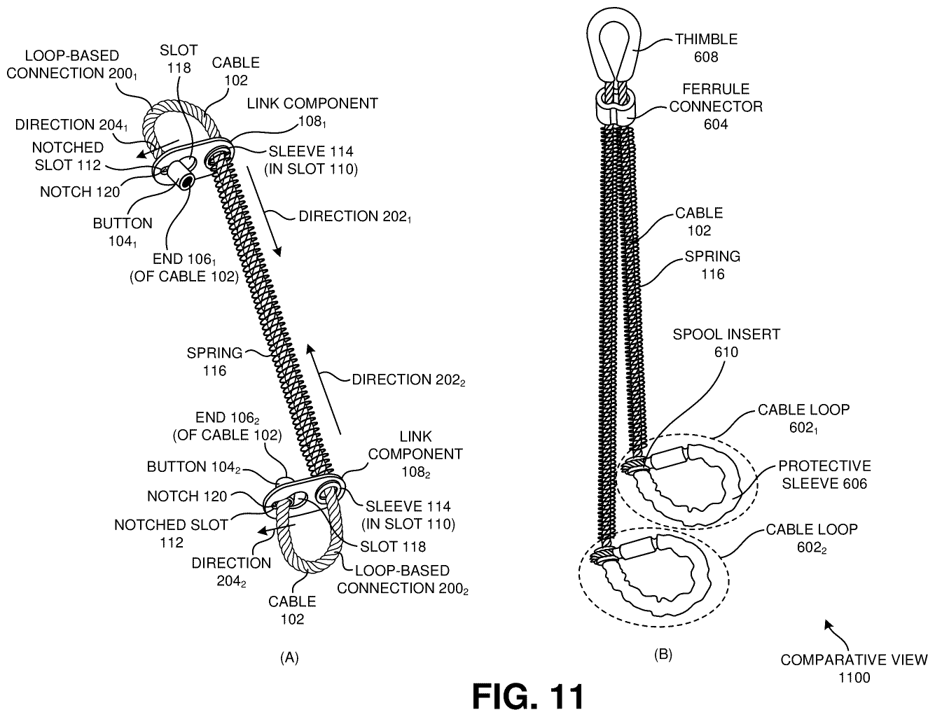

FIG. 11 is a comparative view 1100 showing two loop termination styles, including a quick-link mechanism and a fixed closed-loop ferrule, according to one or more embodiments. FIG. 11 is a comparative view 1100 of two loop termination variants, according to one or more embodiments. Subfigure FIG. 11A illustrates a quick-link configuration similar to link components 108₁-108₂ shown in FIG. 1, including a slot 118 and a notched slot 112 with a button 104₁ engaged, according to one embodiment. A locking notch 1102 (corresponding to notch 120 of FIG. 1) may retain the cable end after loop formation, according to this embodiment. Subfigure FIG. 11B illustrates a factory-fixed closed loop with a swaged ferrule connector 604, eliminating the need for disconnection-based installation, according to this embodiment. The protective sleeves 606 and optional thimble insert (e.g., insert 608) are shown in both subfigures, according to this embodiment. These variations demonstrate alternative installation methods with and/or without disconnection, building upon the spring-tensioned design of FIG. 2, according to this embodiment.

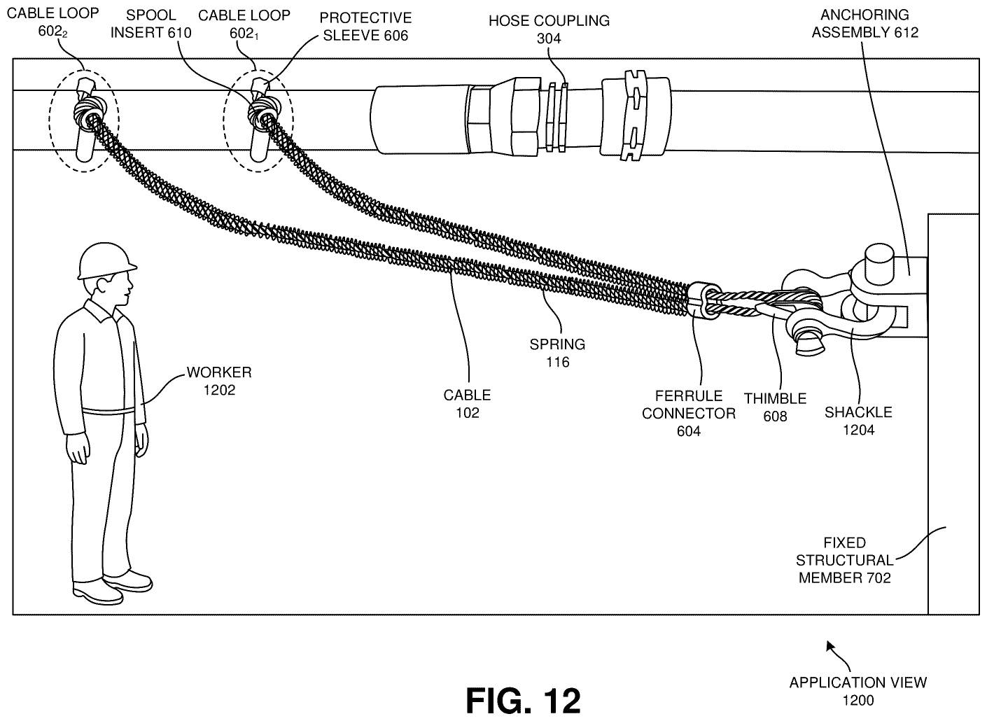

FIG. 12 is an application view showing the double cable hose choker installed on a pressurized hose in an operational environment, such as a drilling rig and/or fracking site, with the anchoring assembly 612 secured to the fixed structural member 702, according to one or more embodiments. FIG. 12 is an operational deployment view 1200 showing the hose 302 installed on a drilling rig and/or fracking site with the double cable hose choker assembly 600 in place, according to one or more embodiments. The hose 302 is shown suspended vertically and/or horizontally, with the first cable loop 602₁ and the second cable loop 602₂ encircling the hose 302 at offset locations. The anchoring assembly 612 is connected via a shackle 1202 to the fixed structural member 702. A worker 1204 is shown for scale and installation context, according to this embodiment. The double cable hose choker assembly 600 is installed without breaking fluid connection, consistent with in-operation coupling principles discussed in FIG. 3, according to this embodiment. This figure illustrates how the invention is employed in field scenarios where whip suppression and dynamic cable tightening are critical to user safety, according to one embodiment.

In one or more embodiments, and as shown in FIGS. 6 and 7, a hose restraint device 100 includes a first cable loop 602₁ and a second cable loop 602₂ formed from a continuous flexible cable 102. Each cable loops are longitudinally spaced apart along a pressurized hose 302 such that each loop wraps circumferentially around a distinct region of the hose 302, according to one embodiment. The continuous cable 102 terminates in a common anchoring assembly 612, which receives tensile load during the hose 302 separation events, according to one embodiment. A protective sleeve 606 is positioned around each of the cable loops 602₁ and 602₂, forming a contact interface with the outer surface of the hose 302 to reduce localized abrasion and deformation during tightening, according to one embodiment.

As best illustrated in FIG. 7, the longitudinal spacing between the cable loops 602₁ and 602₂ is approximately 12 inches, though this may vary within a range of about 8 to 16 inches depending on the diameter of the hose 302 and application, according to one embodiment. This spacing allows the hose restraint device 100 to engage a wider area of the hose 302 body to improve mechanical load distribution and/or reduce concentration of stress at a single point, particularly during a coupling failure, according to one embodiment.

As shown in FIGS. 6 through 8, the protective sleeves 606 may be constructed from abrasion-resistant materials such as polyester, neoprene, and/or other high-durability composites that resist frictional wear when looped tightly against the hose 302, according to one embodiment. In FIG. 8, a spool insert 610 is optionally disposed between the cable 102 and the hose 302 surface within loop 602 to disperse radial compression forces during tightening and to prevent pinching and/or cutting of the hose wall 802 of the hose 302, according to one embodiment.

In some embodiments, the cable 102 used to form the first cable loop 602₁ and the second cable loop 602₂ comprises a multi-stranded steel wire construction coated with a corrosion-resistant polymer, such as nylon and/or PTFE, which ensures both high tensile strength and long-term durability in corrosive and/or outdoor environments, as depicted by the cable 102 running through the protective sleeves 606 in FIGS. 6 and 9. The termination of the cable 102 legs is accomplished using the swaged and/or crimped ferrule connectors 604, visible in FIGS. 6 and 10, which permanently secure the cable geometry without the need for mechanical fasteners, according to one embodiment.

FIG. 11 further illustrates that ferrule-based closures (e.g., ferrule connectors 604) may be implemented instead of quick-link mechanisms to simplify installation and eliminate reliance on field assembly, according to one embodiment. Specifically, SubFIG. 11B depicts swaged ferrule connectors 604 used to maintain the pre-formed loop shape while also providing high pull resistance during he hose 302 failure scenarios, according to one embodiment.

The double cable hose choker assembly 600 is specifically designed for use with high-pressure industrial hoses, including hydraulic, pneumatic, frac, and/or mud hoses, all of which are subject to violent hose whip if failure occurs at the hose coupling 304. FIG. 12 shows the hose 302 deployed on a drilling rig with the first cable loop 602₁ and the second cable loop 602₂ installed in staggered positions, and the anchoring assembly 612 secured to a rig-mounted fixture (e.g., fixed structural member 702) via the shackle 1204. A human FIG. 1202 (e.g., worker 1202) provides scale for practical field implementation, according to one embodiment.

The dynamic performance of the system during a failure event is captured in FIG. 9, which illustrates that as the hose 302 contracts radially and longitudinally under a loss of pressure (Panel B), the first cable loop 602₁ and the second cable loop 602₂ constrict automatically due to axial loading. This cinching action restrains the hose 302 from whipping and/or dislodging, transferring the energy to the anchoring assembly 612. Arrows in Panel C illustrate the force vectors as the cable 102 tightens passively without requiring external mechanisms and/or operator intervention, according to one embodiment.

In embodiments such as that shown in FIG. 10, a multi-loop version of the system may include four loops 602₁, 602₂, 1002₁, and 1002₂ to distribute the load even more broadly across the hose 102 body. These loops may terminate at either the anchoring assembly 612 and/or at split anchors (e,g, anchor 1004₁ and anchor 1004₂), depending on structural layout and hose 102 routing, according to one embodiment. Throughout these embodiments, the protective sleeves 606 may be permanently bonded and/or heat-shrunk onto the cable 102 to prevent axial migration during repeated tightening cycles, ensuring consistent positioning and/or functionality during field use, according to one embodiment.

Finally, the restraint assembly is designed to allow field installation without detaching the hose 302 from its pressurized connection, as demonstrated in FIG. 12, where the first cable loop 602₁ and the second cable loop 602₂ are shown fully installed on an operational line without requiring system shutdown and/or decoupling, according to one embodiment.

Installed within at least one of the cable loops, such as the first cable loop 602₁ and the second cable loop 602₂ shown in FIG. 6, is a plastic spool insert 610 and/or thimble insert, as illustrated in FIG. 8, according to one or more embodiments. This spool insert 610 is positioned between the cable 102 and the outer surface of the hose 302, and is configured to facilitate smooth constriction of the cable loops during axial loading. The spool insert 610 ensures that as the cable loops tighten around the hose 302 during a pressure failure event, the cable 102 transitions inward uniformly without pinching and/or cutting into the hose jacket (e.g., protective sleeve 606). This controlled cinching action enables the double cable hose choker assembly 600 to grip the hose 302 securely and progressively, as shown in the failure sequence of FIG. 9, according to one embodiment. Unlike rigid hobble clamps that rely on fixed hardware and may not adapt dynamically to hose 302 deformation, the use of the spool insert 610 in conjunction with the flexible cable 102 allows the choker to conform to the changing diameter of the hose 102 and maintain consistent engagement, thereby offering a superior safety advantage, according to one embodiment.

The double cable hose choker assembly 600 is specifically engineered to continue tightening onto the hose 302 under axial load, which is critically important in applications involving Kelly hoses on drilling rigs, according to one or more embodiments. As illustrated in FIG. 6, the first cable loop 602₁ and the second cable loop 602₂ are configured to constrict progressively around the hose 302 during pressure loss and/or coupling failure, such as the scenario depicted in FIG. 9, Panels B and C. This auto-tightening behavior becomes essential when securing large-diameter mud hoses, which can weigh several thousand pounds and are commonly suspended 70 to 80 feet above the rig floor where personnel (e.g., worker 1202) are actively working, as shown in the field deployment context of FIG. 12. In the event of a hose 302 end failure, the double cable hose choker assembly 600's ability to maintain and increase its grip rather than loosening and/or slipping like some conventional rigid restraints helps prevent catastrophic hose 302 drop events, thereby enhancing safety for crew members on the rig floor, according to one embodiment.

The double cable hose choker assembly 600 is capable of securely restraining high-pressure hoses, such as frac hoses operating at pressures up to 15,000 PSI, according to one or more embodiments. As shown in FIGS. 6 and 7, the choker includes two longitudinally spaced loops, the first cable loop 602₁ and the second cable loop 602₂ that wrap tightly around the hose 302 and terminate at a common anchoring assembly 612. This dual-loop configuration enhances stability and reduces localized stress, particularly under extreme pressure surges. Rotary and Kelly hoses used on drilling rigs are typically required to meet a minimum restraint breaking strength of 16,000 pounds. The cable hose choker assembly 600, however, significantly exceeds this standard by achieving a minimum breaking strength (MBS) of 48,000 pounds, according to one embodiment. The construction includes robust ferrule connectors 604 and high-strength cable materials configured to cinch into the hose wall 802, particularly aided by the thimble 608, as shown in FIG. 8, ensuring the double cable hose choker assembly 600 grips more effectively under load. This superior strength and gripping performance make the double cable hose choker assembly 600 an optimal solution for heavy-duty oilfield environments, such as those illustrated in FIG. 12, according to one embodiment.

The double cable hose choker assembly 600 design includes two looped cable legs, i.e., the first cable loop 602₁ and the second cable loop 602₂ spaced approximately 12 inches apart along the length of the hose 302, as illustrated in FIGS. 6 and 7. This specific spacing helps prevent improper installation by clearly indicating correct placement zones and improves safety by distributing the restraining force over a wider surface area. During a pressure release and/or coupling failure, the dual-loop arrangement enables the double cable hose choker assembly 600 to grip more effectively across multiple regions of the hose 302, enhancing both stability and retention during whip events, according to one embodiment.

The double cable hose choker assembly 600 functions as a secondary restraint system, designed to be installed near the end of a pressurized hose 302, such as a Kelly and/or frac hose. Its purpose is to mitigate whip-induced motion and/or prevent catastrophic hose fall incidents, acting as a backup support during failure scenarios, as demonstrated in the deployment context of FIG. 12, according to one embodiment.

In drilling applications, Kelly hoses are suspended approximately 70 to 80 feet above the rig floor and may weigh several thousand pounds. In the event of a fitting and/or hose-end failure, it is vital that the restraint does not slide off the hose 302. As shown in FIGS. 6 through 9, the double cable hose choker assembly 600 forms looped restraints that cinch inward onto the hose 302 under tension. This cinching capability, enabled by the loop geometry, the ferrule connector 604, and optional thimble 608, prevents detachment from the hose 302 body and helps avoid potentially fatal equipment falls onto the workers 1202 below, according to one embodiment.

The double cable hose choker assembly 600, as represented in FIG. 12, operates as a comprehensive restraint system engineered to prevent Kelly hoses from falling onto the rig floor. It incorporates two staggered cable loops, i.e., the first cable loop 602₁ and the second cable loop 602₂, the protective sleeves 606, and the anchoring assembly 612 that couples to a fixed structural member 702, together forming an integrated system for whip suppression and fall arrest in hazardous high-pressure hose environments, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A hose restraint assembly for a pressurized fluid hose, comprising:
a first cable loop and a second cable loop formed from a continuous cable and spaced longitudinally apart along the hose,
each cable loop configured to encircle the hose and terminate at a common anchoring assembly; and
a protective sleeve positioned around each of the first and second cable loops and disposed in contact with the hose, and
wherein the common anchoring assembly is configured to transfer tensile energy from the continuous cable to a fixed structural support during a hose failure event,
wherein the first and second cable loops are configured to constrict and tighten passively around the hose as the hose contracts under pressure.

2. The hose restraint assembly of claim 1, wherein the first cable loop and the second cable loop are spaced apart by a distance between 8 and 16 inches along the length of the hose.

3. The hose restraint assembly of claim 1, wherein the protective sleeve comprises an abrasion-resistant material selected from at least one of polyester, neoprene, polyurethane, and a woven textile composite.

4. The hose restraint assembly of claim 1, wherein the continuous cable comprises a multi-stranded steel cable coated with a corrosion-resistant polymer.

5. The hose restraint assembly of claim 1, wherein the common anchoring assembly comprises at least one of a swaged metallic eyelet and a clevis connector configured to interface with at least one of a shackle and a rig-mounted fixture.

6. The hose restraint assembly of claim 1, wherein each of the first cable loop and the second cable loop includes a thimble insert disposed between the cable and the hose surface, the thimble configured to reduce deformation of the hose during constriction.

7. The hose restraint assembly of claim 1, wherein the protective sleeves are permanently fixed to the cable to loops prevent axial sliding during operation.

8. The hose restraint assembly of claim 1, wherein the hose is a high-pressure industrial hose selected from a group consisting of at least one of hydraulic, pneumatic, frac, and mud hoses.

9. The hose restraint assembly of claim 1, wherein the continuous cable terminates at the common anchoring assembly through at least one of a swaged and crimped ferrules formed at each cable leg.

10. The hose restraint assembly of claim 1, wherein the assembly is configured to be installed without detaching the hose from at least one of its pressurized connection and fitting.

11. The hose restraint assembly of claim 1, wherein the first and second cable loops are dimensioned and positioned to dissipate tensile energy by engaging discrete outer surface regions of the hose during a whip-inducing failure event.

12. A hose restraint device, comprising:
a single length of flexible cable configured to form a first loop and a second loop, the first loop and the second loop being spaced apart longitudinally along a hose when the device is installed, each of the first loop and the second loop configured to wrap circumferentially around an outer surface of the hose;
a protective sleeve disposed over at least a portion of each of the first and second loops, the protective sleeve comprising a flexible abrasion-resistant material selected from at least one of a polyester, rubber, and a polymer composite, and configured to interface directly with the hose surface to reduce localized compression and wear;
an insert optionally disposed between the cable and the hose surface within at least one of the loops, the insert configured to distribute compressive force and prevent pinching of the hose wall during tightening; and
a pair of crimped ferrules terminating opposing ends of the cable, the ferrules permanently securing the cable to maintain the looped geometry;
wherein the cable is configured to automatically tighten around the hose in response to axial tension resulting from a pressurized fluid failure event, such that both the first and second loops constrict concurrently to restrain the hose, and
wherein the longitudinal spacing between the first loop and the second loop is selected to increase energy absorption and distribute mechanical load along multiple regions of the hose body.

13. The hose restraint device of claim 12, wherein the longitudinal spacing between the first loop and the second loop is between 8 inches and 16 inches.

14. The hose restraint device of claim 13, wherein the protective sleeve further comprises an inner lining layer configured to reduce friction between the cable and the hose surface.

15. The hose restraint device of claim 13, wherein the flexible cable comprises a multi-stranded steel wire construction with a corrosion-resistant coating.

16. The hose restraint device of claim 13, wherein the ferrules are formed from at least one of aluminum, stainless steel, and another metallic alloy and are mechanically swaged onto the cable ends to prevent slippage.

17. The hose restraint device of claim 13, wherein both the first loop and the second loop are formed using a pre-measured cable length specific to a hose diameter range.

18. The hose restraint device of claim 13, wherein the protective sleeve is at least one heat-shrunk and bonded to the cable to prevent relative movement between the sleeve and the cable during use.

19. The hose restraint device of claim 13,
wherein the at least one thimble and spool insert comprises a non-metallic composite material selected for impact dispersion and thermal resistance,
wherein the cable is configured to constrict without the aid of external tensioning hardware, relying solely on induced axial force from at least one hose contraction and pressure reversal,
wherein the device is configured to be installed on the hose without requiring disconnection of the hose from its fitting,
wherein at least one of the first loop or the second loop is color-coded or marked to indicate proper placement along the hose during installation.

20. A multi-loop hose choker system, comprising:
a plurality of cable loops spaced longitudinally along a pressurized hose;
a protective sleeve surrounding each of the plurality of cable loops;
at least one thimble and spool insert optionally disposed between each cable loop and a surface of the hose; and
an anchoring assembly coupled to the ends of the cable and attachable to a structural frame,
wherein the at least two staggered loops are configured to progressively cinch onto the hose surface in response to axial load resulting from at least one of a coupling and pressure failure, thereby distributing force across multiple locations and reducing hose whip, and
a crimped termination fixed at each end of the cable to secure the loops.
